(19) United States
(12) Patent Application Publication
(10) Pub. No.: US 2005/0160017 A1
(43) Pub. Date: Jul. 21, 2005

(54) AN APPARATUS FOR CONSISTENT LINKING OF RATES OF RETURN

(76) Inventor: Iourii K. Chestopalov, Willowdale (CA)

Correspondence Address: IOURII CHESTOPALOU, 240 DUNFOREST AVE., WILLOWDALE, ON, M2N-4Y9, CA

(21) Appl. No.: 10/905,553

(22) Filed: Jan. 10, 2005

(30) Foreign Application Priority Data
Jan. 16, 2004 (CA) 2452107

(51) Int. Cl. G06F 17/60

(52) U.S. Cl. 705/30; 705/35; 705/37

(57) ABSTRACT

Available accounting, trading, investment performance measurement and analytical systems and apparatuses calculate precise rate of return for a single period. An apparatus for consistent linking calculates precise overall rate of return from rates of return of smaller periods composing the overall period. It can be used for calculating rate of return for sequential, non-sequential and equal and non-equal period compositions, as well as for calculating rate of return across slices of securities. Apparatus composed of request processor; permanent data storage; temporary structured data storage; consistent linking mathematical processor; feedback loop to feed permanent data storage. Integral characteristics of sub-periods are calculated only once and then are used to produce rate of return for any longer periods that include these sub-periods.

### CROSS REFERENCE TO RELATED APPLICATIONS

This Application is based on and claims priority to Canadian Patent Application, No. 2452107, filing date Jan. 16, 2004.

### BACKGROUND OF THE INVENTION

1. Field of the Invention

This invention relates to apparatuses for calculating rate of return for accounting, investment and trading businesses analysis and strategies development.

2. Description of the Related Art

Available systems and apparatuses calculate precise rate of return for a single period. There are no systems or apparatuses to calculate precisely rate of return for a period composed from the smaller ones, based on rate of returns for composing periods, when there are cash transactions within the period. Performing cash transactions is a normal business for accounting, trading and investment analytical systems. Geometric linking method used presently produces inconsistent results. It means that it produces rate of return different from rate of return calculated directly for the whole period. The difference can be of the order of percents and more depending on the business case. This value of error is not accepted in most financial applications. However, geometric linking computationally is fast operation. It also requires much less data to be processed. These is why it is still in a wide use. Detailed consideration of geometric linking method and its disadvantages can be found in [Spaulding, David, 1997, “Measuring Investment Performance”, McGraw-Hill]. In the Table 1 below an error introduced by geometric linking is shown for a few business scenarios.

TABLE 1
Differences in rates of return for different methods compared to
internal rate of return (IRR).

| | | 3 | | | |
|---|---|---|---|---|---|
| | | Cash | | | |
| | 2 | Flow | 4 | 5 | |
| | Standard | divided | IRR (true | IRR minus | |
| 1 | Deviation | by | internal | Modified | 6 |
| Average | of | Beg. | rate of | Dietz | IRR minus |
| period | period | Market | return) | rate of | Geometric |
| return | returns | Value | formulae | return | linking |
| 0.09 | 0.03 | 1.12 | 0.82228 | 0.02860 | 0.05062 |
| 0.04 | 0.08 | 0.96 | 0.25169 | 0.00296 | −0.01644 |
| 0.12 | 0.11 | 0.09 | 1.20685 | 0.00685 | −0.00536 |
| 0.05 | 0.05 | 0.09 | 0.43188 | 0.00111 | 0.00096 |
| 0.21 | 0.20 | −0.15 | 2.27982 | −0.05351 | −0.18698 |
| 0.07 | 0.04 | −0.07 | 0.64333 | −0.00220 | −0.00145 |
| 0.10 | 0.11 | 0.31 | 0.82055 | 0.00923 | −0.02813 |
| −0.14 | 0.23 | 0.96 | −0.72084 | 0.04566 | 0.00338 |
| −0.02 | 0.07 | 3.06 | −0.23563 | 0.00621 | −0.11418 |
| 0.00 | 0.01 | −0.80 | −0.0753 | 0.00086 | −0.04197 |

In the column 6 the differences between internal rate of return for a single period and rate of return calculated from internal rates of return for smaller periods composing the whole period using geometric linking are in the range 5-18.7%. In most business cases this is unacceptable error. However, despite such big errors produced by geometric linking it is still widely used method in performance measurement, trading and accounting businesses. The reasons are convenience, simplicity and speed because these business systems process huge volumes of data.

Usage of direct methods for calculating rate of return requires intensive computations demanding large system resources and often long processing time.

This is why the efforts were made to optimize calculating rate of return for a single period depending on the business purpose. Example can be The U.S. Pat. No. 6,564,191 granted on May 13, 2003, by author Reddy Visveshwar N, called “Computer-implemented method for performance measurement consistent with an investment strategy”. However, in this patent rate of return is still calculated for a single period.

So, current systems, methods and apparatuses for producing rate of return rely on calculation of rate of return for a single period or use geometric linking. Geometric linking is using rates of return of composing periods to find the rate of return for the whole period. However, it is producing big non-systematic error.

### BRIEF SUMMARY OF THE INVENTION

Apparatus for calculating rate of return for accounting, investment and trading business analysis and strategies development described below provides consistent linking for calculating rate of return for a bigger period composed of the smaller sub-periods. It also allows calculating precise rate of return across different securities and their groups within the same or different investment portfolios. It is also calculates rate of return simultaneously across non-sequential periods with different length and different securities or their groups. Consistent linking calculator as the whole concept and implementing this concept apparatus is introduced in this invention and means the following: some apparatus is performing consistent linking operation if the rate of return calculated for the whole period is equal to exactly or with any specified accuracy to rate of return produced from known rates of return and other integral characteristics of composing sub-periods. Integral characteristics of sub-period are associated with this sub-period only and do not depend on the data from other sub-periods. These integral characteristics are calculated once and then are used for calculating rate of return of any arbitrary period that includes this sub-period.

Apparatus includes consistent linking mathematical processor and set of other mandatory components communicating in a certain way. Though speculatively mathematical processor can be substituted by human being armed with pencil and paper, in real life it's impossible to calculate rate of return for real business transactions using manual calculations. It's the same as if somebody denies any innovation in locomotive on the mere ground that the same load can be delivered by sufficient number of horses. Certainly components can be implemented in different ways—for example, consistent linking mathematical processor can be implemented by computer program written in C++, Visual Basic, Java etc; specialized processors, analogous electrical or even ultrasound signals processing and so on. However, in any of these scenarios it will be consistent linking mathematical processor—absolutely unique component that never existed before, as well as topology of connections and interactions with other components, whose unique combination provides calculation rate of return from subperiods' integral values, thus creating new unique entity, apparatus—consistent linking calculator that never existed before. So, having just consistent linking algorithm in hands doesn't mean automatic or obvious way of getting the final result—rate of return. There should be a certain unique combination of physical components connected in a certain unique way to produce the required outcome. From the time when somebody has been handed the algorithm till getting final result there inevitably will be a phase when consistent linking calculator must exist. Just there is no other feasible way to receive rate of return from algorithm directly but to have apparatus capable to do this, whatever form and shape this apparatus takes. It is possible to put the whole consistent linking calculator into one computer. However, even in this case there will be distinguished same components and the same unique connections between them. Thus the unity of new entity, this invention, apparatus will be preserved.

Using this apparatus produces essential economic result in relation to investment industry and accounting business. That is, apparatus calculates precise rate of return much faster than any existing apparatus, it requires much less data, it provides exceptional reusability of computed once data, it allows to do new useful types of investment data analysis that are impossible within existing methods, approaches and accordingly appropriate existing apparatuses. To say, it also manufactures new useful information, new knowledge never available before but nonetheless highly demanded by all related businesses. However simple it may seem, this apparatus never existed before and none of the existing apparatuses can do what this apparatus does—calculation of precise rate of return from subperiods integral values.

### BRIEF DESCRIPTION OF THE SEVERAL VIEWS OF THE DRAWINGS

FIG. 1. Consistent Linking Calculator for calculating rate of return. 1—Request to calculate integral rate of return. 2—Request Processor. 3—Permanent Data Storage. 4—Temporary structured data storage. 5—Mathematical Processor. 6—Output result—integral rate of return.

FIG. 2. Consistent Linking Calculator for calculating rate of return retrieving itself input data from permanent storage. 1—Request to calculate integral rate of return. 2—Request Processor. 3—Permanent Data Storage. 4—Temporary structured data storage. 5—Mathematical Processor. 6—Output result—integral rate of return.

FIG. 3. Consistent Linking Calculator for calculating rate of return when mathematical processor has internal temporary storage. 1—Request to calculate integral rate of return. 2—Request Processor. 3—Permanent Data Storage. 5—Mathematical Processor. 6—Output result—integral rate of return.

### DETAILED DESCRIPTION OF THE PREFERRED EMBODIMENTS

1. Overview of the Invention

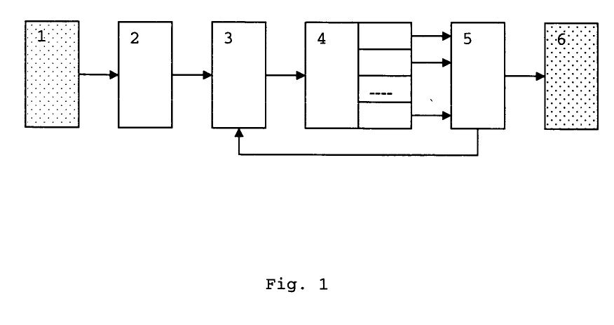

In one embodiment, referring to FIG. 1, a block diagram is provided with the various components in one embodiment. Client request 1 is sent to request processor 2. Request processor 2 handles set of functionalities, including security and performance issues, scheduling, forming request for data retrieval etc. Request for data is sent to permanent data storage 3 that provides requested set of data as input for temporary data storage 4. Temporary data storage structured such that both raw and integral values can be accessed on subperiod base sequentially or randomly. These structured data are used by mathematical processor 5 performing one or a set of consistent linking operations. Output result is sent to output 6 where it can be retrieved by client. At the same time mathematical processor stores computed integral subperiod values, and optionally output result, in the permanent storage 3. If any following request requires data for that particular period, then only integral values will be sent to mathematical processor, not the raw ones. Eventually only integral values will be used by mathematical processor. The other alternative is that request processor can issue request for producing all integral subperiods' values first, or request processor sends only integral values available to it from other sources.

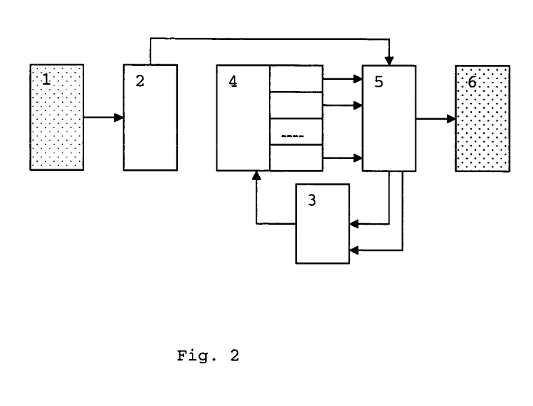

Another embodiment of invention referring to FIG. 2.

Mathematical processor receives request and then creates data request to permanent storage.

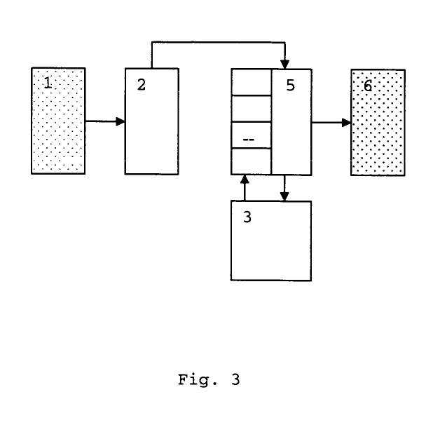

Another embodiment of invention referring to FIG. 3.

Temporary storage is embedded into mathematical processor.

Consistent linking mathematical processor, having one or multiple execution paths for consistent linking and feedback loop for storing integral subperiods values in the permanent storage are unique components of the apparatus that do not present in the prior art methods, systems and apparatuses for calculating rate of return for the overall period, when cash transactions within the subperiods present. The whole concept of consistent linking apparatuses didn't exist in prior art implementations as well. Consistent linking apparatus and its workflow are demonstrated below for time weighted rate of return. Another type of rate of return is money weighted rate of return, also called internal rate of return (IRR). Detailed description of both rates of return is in [Feibel, Bruce J., Investment Performance Measurement, 2003, John Wiley & Sons. Inc.]

Consistent linking mathematical processor and its connection to permanent or temporary storage of integral subperiod values, and appropriate structuring of storage(s) based on subperiods integral values and providing sequential and (or) random access, are mandatory components of the apparatus. Without these apparatus' components consistent linking operation cannot be implemented.

IRR can be found using equations for discrete or continuous compounding. Below discrete compounding is considered. Continuous compounding can be considered in a similar way.

$$B + {\sum }_{j = 1}^{N} {{C}_{j} ( 1 + R )}^{- {T}_{j}} - {E ( 1 + R )}^{- {T}_{N + 1}} = 0 \qquad ( 1 )$$

where B—beginning market value; E—ending market value; Cⱼ—cash flow; Tⱼ—time from beginning of period until cash flow occurred or length of the overall period (T_{N+1}) measured in units of chosen atomic period; R—IRR to be found.

Atomic period means the period to which the calculated rate of return is applied to. For example, the whole period is two months. Atomic period is one month. Then R is related to one month. For discrete compounding the equivalent form of equation (1) can be derived by multiplying both parts of equation by
(1+R)^{T}^{_{N+1}}
Equation (1) will be rewritten as follows:

$$E = {B ( 1 + R )}^{{T}_{N + 1}} + {\sum }_{j = 1}^{N} {{C}_{j} ( 1 + R )}^{Tj} \qquad ( 2 )$$

where Tⱼ is now time period from when cash flow occurred till the end of the period measured in units of chosen atomic period. T_{N+1} is the length of the overall period.

Time is measured in units of chosen atomic period. It means calculated rate of return R is the rate of return for atomic period.

Equation (2) can be analyzed using Taylor series expansion. Taylor series is a form of approximate presentation of function in the vicinity of a particular point [see J. H. Pollard, “A Handbook of Numerical and Statistical Techniques”, Cambridge University Press, 1977]. The accuracy of presentation depends on how rapidly the magnitude of terms falls and the range of arguments. The smaller the range, the higher approximation accuracy with the same number of terms.

Taylor expansion is used to approximate non-linear terms in the sum (2) using linear or linear and quadratic terms. First solution has been found using Taylor expansion at point R=0. Thus found solution R=R₀ is used then as a point for Taylor expansion. Using Taylor expansion at R=0 and considering atomic period T_{N+1}=1, equation (2) transforms to the following:
E=B(1+R₀)+Σ[Cⱼ+CⱼTⱼR₀] (3)

Solution of this equation is as follows

$${R}_{0} = \frac{E - B - {\sum }^{} {C}_{j}}{B + {\sum }^{} {C}_{j} {T}_{j}} \qquad ( 4 )$$

This is Modified Dietz formula (present industry standard adopted by AIMR—time weighted rate of return). Thus IRR and time weighted rate of return (TWRR) are two interrelated methods with TWRR derived from IRR. Until today these methods are considered as two separate entities derived independently (that's how they were derived historically). Given this relationship it can be shown that consistent linking for TWRR is related to IRR as an IRR's approximation, while producing precise rate of return for TWRR using subperiod values. It is also possible to derive consistent linking for IRR method that produces correct IRR value from subperiods' IRR values with any a'priori set accuracy.

Consistent Linking for Time Weighted Rate of Return

Example of consistent linking mathematical processor is the one implementing one execution path for equal sequential periods using the following embedded algorithm:

$$\begin{matrix}{R}_{S0} = \frac{{B}_{1} [ {\prod }_{n = 1}^{N} ( 1 + {R}_{n} ) - 1 ] + {\sum }_{n = 1}^{N} [ {S}_{Cn} \overline{{P}_{N}} ( {R}_{n} ) - {S}_{n} ]}{{B}_{1} + \frac{1}{N} {\sum }_{n = 1}^{N} [ {S}_{Tn} + ( N - n ) {S}_{n} ]} \\ where {S}_{Tn} = {\sum }_{i = 1}^{{I}_{n}} {C}_{{I}_{k} i} ( 1 + {T}_{ni} {R}_{n} ) , {S}_{n} = {\sum }_{i = 1}^{{I}_{n}} {C}_{{I}_{k} i} , {S}_{Cn} = {\sum }_{i = 1}^{{I}_{n}} {C}_{{I}_{k} i} {T}_{ni} \\ \overline{{P}_{N}} ( {R}_{n} ) = {\prod }_{i = n + 1}^{N} ( 1 + {R}_{i} ) if n < N , \\ \overline{{P}_{N}} ( {R}_{n} ) = 1 if n = N\end{matrix} \qquad ( 5 )$$

Please note that execution path (5) of consistent linking mathematical processor implements Modified Dietz formulae without using Taylor expansion at all.

If periods have different length, mathematical processor can have two execution paths—one for sequential equal periods, the other one for sequential non-equal periods, and so on. Consistent linking mathematical processor can have many execution paths, however each of them relies on input structured on subperiod base, being it raw or integral subperiod data.

Sub-periods can be quite small because how's accurate the final rate of return is determined by computational precision, not by the method itself because method produces exact value of rate of return. For example, if fund has 100 transactions a day and one wants to calculate rate of return for 20 years based on daily returns, then values S_{Tn} and Sₙ should be calculated with relative accuracy 10⁻⁵ (10⁻³×(365×20)^{0.5}) and product Cₙᵢ(1+Rₙ) accordingly with relative accuracy 10⁻⁶ in order to get an accuracy of final rate of return about 10⁻³. Computers provide accuracy much high than 10⁻⁶.

These integral characteristics to be calculated only once and then can be used without changes for calculating rate of return for any bigger period.

Thus it becomes possible to calculate precise rate of return for any combination of different securities and their groups across different periods. Whatever combination is chosen, consistent linking of rates of return for all these non-overlapping combinations comprising the whole set of data and time periods will always produce the same rate of return.

Having this kind of functionality is crucially important to allow optimizing investment portfolio using mathematical optimization methods and models. Ability of consistent linking calculator to produce rate of return for any arbitrary subsets of data based on small amount of input data results in an excellent performance. It allows creating real time investment portfolio optimization and monitoring systems. Those things are practically impossible with existing systems for calculating rate of return.

Numerical example illustrating consistent linking for Modified Dietz method is shown below. It is based on simulated data for three monthly periods. First rates of return for each period were calculated, then they were linked for a total period three months using consistent linking. Table 2 shows simulated data, table 3 results of calculation.

TABLE 2
Simulated data for three consecutive periods

| Period 1 | | | Period 2 | | | Period 3 | | |
|---|---|---|---|---|---|---|---|---|
| Cash | Transaction | Market | Cash | Transaction | Market | Cash | Transaction | Market |
| Trans. | Date | Value | Trans. | Date | Value | Trans. | Date | Value |
| 0 | 0 | 123 | 0 | 0 | 525 | 0 | 0 | 935 |
| −15 | 1 | 120 | 15 | 1 | 520 | −25 | 1 | 920 |
| 40 | 3 | 180 | 40 | 3 | 580 | 40 | 3 | 980 |
| 10 | 4 | 210 | 10 | 4 | 610 | −10 | 4 | 1010 |
| −26 | 6 | 206 | 26 | 6 | 606 | −26 | 6 | 1006 |
| 3 | 7 | 220 | 3 | 7 | 620 | −3 | 7 | 1020 |
| 7 | 8 | 220 | 7 | 8 | 620 | 7 | 8 | 1020 |
| 2 | 11 | 230 | 2 | 11 | 630 | 2 | 11 | 1030 |
| 3 | 15 | 220 | 3 | 15 | 620 | 3 | 15 | 1020 |
| 20 | 17 | 240 | 20 | 17 | 640 | 20 | 17 | 1040 |
| 10 | 18 | 260 | 10 | 18 | 660 | −10 | 18 | 1060 |
| 15 | 19 | 270 | 15 | 19 | 670 | −15 | 19 | 1070 |
| 3 | 20 | 290 | 3 | 20 | 690 | 3 | 20 | 1090 |
| 20 | 22 | 310 | 20 | 22 | 710 | 20 | 22 | 1110 |
| 16 | 24 | 350 | 16 | 24 | 750 | 16 | 24 | 1150 |
| 33 | 26 | 365 | 33 | 26 | 765 | 33 | 26 | 1165 |
| 40 | 28 | 400 | 40 | 28 | 800 | −40 | 28 | 1200 |
| 11 | 29 | 450 | 11 | 29 | 850 | 11 | 29 | 1250 |
| 25 | 29 | 490 | 25 | 29 | 890 | −25 | 29 | 1290 |
| −20 | 30 | 520 | 20 | 30 | 920 | −20 | 30 | 1320 |

TABLE 3
Rate of returns calculated for each and total
periods using time weighted rate of return
formulae (Modified Dietz).

| | | | Total | Total |
|---|---|---|---|---|
| | | | Period, | period, |
| | | | direct | consistent |
| Period | Period | Period | calculation, | linking |
| 1, % | 2, % | 3, % | % | using % |
| 154.726 | 12.434 | 45.6618 | 203.726 | 203.726 |

Table 3 shows that total rates of return calculated using direct calculation of time weighted rate of return and consistent linking are exactly the same. Geometric linking produces in this case 317.17% that is far away from the correct result 203.726%.

Anther illusstrative feature of the above exaple is the data volume rewuired to calculate rate of return for the whole period based on conventional approcach and the one used by consistent linking calculator. For the conventional approach it's all roughly 200 numbers listed in the table 2. Consistent linking calculator needs 9 numbers. In real situation there will be at least thousands numbers for conventional approach, while consistent linking calculator still needs only 9 numbers calculated once.

Although only some embodiments of the present invention have been described and illustrated, the present invention is not limited to the features of these embodiments, but includes all variations and modifications within the scope of the claims.

The described embodiments are set forth as illustrative examples only; many additional possibilities exist.

1. An apparatus, said consistent linking calculator, for consistent linking of rates of return for accounting, investment and trading such that rate of return produced from integral characteristics of data subsets composing the whole chosen data set is equal to rate of return calculated directly for the chosen data set as a single entity, comprising:
(a) request processor;
(b) permanent data storage;
(c) temporary structured data storage;
(d) consistent linking mathematical processor;
(e) feedback loop to feed permanent data storage;
request processor has input to receive request for producing rate of return and connection to permanent data storage, permanent data storage has connection to temporary data storage structured to store subperiods values, temporary data storage has connection to mathematical processor, consistent linking mathematical processor has feedback connection to permanent data storage and output for calculated integral rate of return.

2. An apparatus in claim 1, wherein request processor has connection to mathematical processor, mathematical processor has connection to permanent data storage to request sending subperiods data to temporary data storage.

3. An apparatus in claims 1, 2, wherein mathematical processor has internal temporary data storage.

4. An apparatus in claims 1, 2, 3 wherein consistent linking calculator doesn't have permanent data storage, doesn't have temporary data storage, doesn't have feedback connection from mathematical processor to permanent data storage, request processor has connection to mathematical processor and request contains all necessary subperiods values.

5. An apparatus in claims 1, 2, 3, 4 wherein consistent linking mathematical processor caches input and (or) computed data.

6. An apparatus in claims 1, 2, 3, 4, 5 wherein consistent linking mathematical processor contains some paths of execution each performing different type of consistent linking.

7. An apparatus in claims 1, 2, 3, 4, 5, 6 wherein request processor has connection to mathematical processor only, permanent storage stores computed subperiods' integral values and has no connection to request processor.

8. An apparatus in claims 1, 2, 3, 4, 5, 6, 7 wherein consistent linking calculator doesn't have request processor and request is already formatted by client accordingly to be processed by permanent data storage or consistent linking mathematical processor.
